(19) United States
(12) Patent Application Publication
(10) Pub. No.: US 2008/0034044 A1
(43) Pub. Date: Feb. 7, 2008

(54) ELECTRONIC MAIL READER CAPABLE OF ADAPTING GENDER AND EMOTIONS OF SENDER

(75) Inventors: Dharmesh N. Bhakta, Austin, TX (US); Trung Ly, Austin, TX (US); Juan F. Obas, Austin, TX (US); Lakshmi Potluri, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,487

(22) Filed: Aug. 4, 2006

(51) Int. Cl. G06F 15/16

(52) U.S. Cl. 709/206

(57) ABSTRACT

A method for an email voice reader capable of adapting gender and emotions of a sender, the method comprising: sending email data by the sender via a directory service, the directory service storing a plurality of attributes of the email data, the plurality of attributes being pre-selected by the sender; receiving the email data by a recipient; enabling the recipient to listen to the email data via the email voice reader, the email data including the plurality of attributes pre-selected by the sender and stored at the directory service; and automatically identifying the gender of the sender by allowing the sender to specify and add a first attribute to the plurality of attributes stored at the directory service, wherein the email voice reader of the recipient automatically recognizes whether to apply a male voice or a female voice based on the added first attribute.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to electronic email readers, and particularly to a method for providing an email reader the ability of adapting the gender and/or emotions and/or attributes of a sender.

2. Description of Background

Tremendous strides have been made in the areas of voice readers and email technologies. Several applications have the capability to read email contents to the recipient. This makes it very convenient for the recipient. However, these email technologies lack a human touch. For example, conventional technologies enable a person to customize these email client applications to read emails in only one monotonous voice. This voice could be a male voice or a female voice. Thus, what happens is that when a recipient receives an email from a male and if the recipient has the option set to read the emails in male voice then the email is read in a male voice.

However, if the recipient receives an email from a female, it is amusing to hear “the female has sent you a mail” in a male voice as well. What would be desirable is to add a human touch to the received emails and enable emails that are received from males to be in a male voice and emails received from females to be in a female voice.

### SUMMARY OF THE INVENTION

The shortcomings of the prior art are overcome and additional advantages are provided through the provision of a method for an email voice reader capable of adapting gender and emotions of a sender, the method comprising: sending email data by the sender via a directory service, the directory service storing a plurality of attributes of the email data, the plurality of attributes being pre-selected by the sender; receiving the email data by a recipient; enabling the recipient to listen to the email data via the email voice reader, the email data including the plurality of attributes pre-selected by the sender and stored at the directory service; and automatically identifying the gender of the sender by allowing the sender to specify and add a first attribute to the plurality of attributes stored at the directory service, wherein the email voice reader of the recipient automatically recognizes whether to apply a male voice or a female voice based on the added first attribute.

The shortcomings of the prior art are overcome and additional advantages are provided through the provision of a system for an email voice reader capable of adapting gender and emotions of a sender, the system comprising: a network; and a host system in communication with the network, the host system including voice reader application software to implement a method comprising: sending email data by the sender via a directory service, the directory service storing a plurality of attributes of the email data, the plurality of attributes being pre-selected by the sender; receiving the email data by a recipient; enabling the recipient to listen to the email data via the email voice reader, the email data including the plurality of attributes pre-selected by the sender and stored at the directory service; and automatically identifying the gender of the sender by allowing the sender to specify and add a first attribute to the plurality of attributes stored at the directory service, wherein the email voice reader of the recipient automatically recognizes whether to apply a male voice or a female voice based on the added first attribute.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method for an email reader capable of adapting the gender and/or emotions of a sender.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a dialogue box including a plurality of property attributes according to the exemplary embodiments of the present invention; and

FIG. 2 illustrates one example of a flowchart illustrating an email reader capable of adapting the gender and/or emotions of a sender according to the exemplary embodiments of the present invention.

### DETAILED DESCRIPTION OF THE INVENTION

One aspect of the exemplary embodiments is a method for an email reader capable of adapting the gender and/or emotions of a sender. In another exemplary embodiment a sender is able to attach a tag to the email including the male or female gender property wherein when the recipient receives the email and it is read in the male or female voice, as specified by the sender. In a further exemplary embodiment, the sender can also embed tags in the text of the email indicating his/her emotions, so when the email is converted from text to speech for the recipient, the voice reflects the emotions of the sender. In yet another exemplary embodiment, the information from the sender can further be stored in the address book of the recipient, so when the recipient receives an email from this sender, it is presented to the recipient in the format desired by the sender.

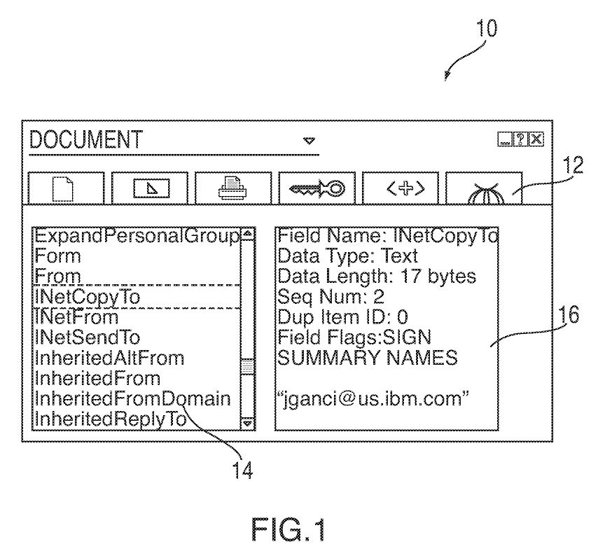

The exemplary embodiments of the present invention build intelligence into the mail client such that emails received from males would be read in a male voice and emails received from females would be read in female voice. This adds a personal touch to the emails. There are several ways this could be implemented. Typically, an email has properties associated with it, as shown in FIG. 1.

Referring to FIG. 1, a dialogue box 10 is shown having a plurality of tabs 12, a first properties column 14, and a second properties column 16. The properties in the first properties column 14 include: ExpandPersonalGroup, Form, INetCopyTo, INetForm, INetSendTo, etc. The properties in the second properties column 16 include: Field name, Data Type, Data Length, etc.

In addition to the existing properties found in the first properties column 14, and the second properties column 16, the exemplary embodiments of the present invention attach an additional property that identifies if the originator of the email is a male or a female. Thus, a sender is in a position to indicate whether the sender is a mail or a female. This is a one-time setting, which in turn will be set as a flag in the email properties.

Therefore, when an email is received at a recipient's end, based on this flag (referred to as the gender flag), the software that reads the emails can automatically switch between a female and a male voice. Hence emails received from a male would be automatically read in a male voice and any emails received from a female would be automatically read in a female voice. For privacy reasons, the sender would be in apposition to determine whether they wish to identify themselves as male or female.

In addition, the male voice is automatically selected from a plurality of male voices that are stored on a server of a directory service (described below). Also, the female voice is automatically selected from a plurality of female voices that are stored on a server of a directory service. The male voices and the female voices may correspond to the age of the sender. In other words, if a sender has specified being a 5-year-old male, or a 21-year-old male or an 80-year-old male, the directory service possesses voice samples of males in those respective age groups. This creates a more realistic email reader adaptation to the gender of the sender.

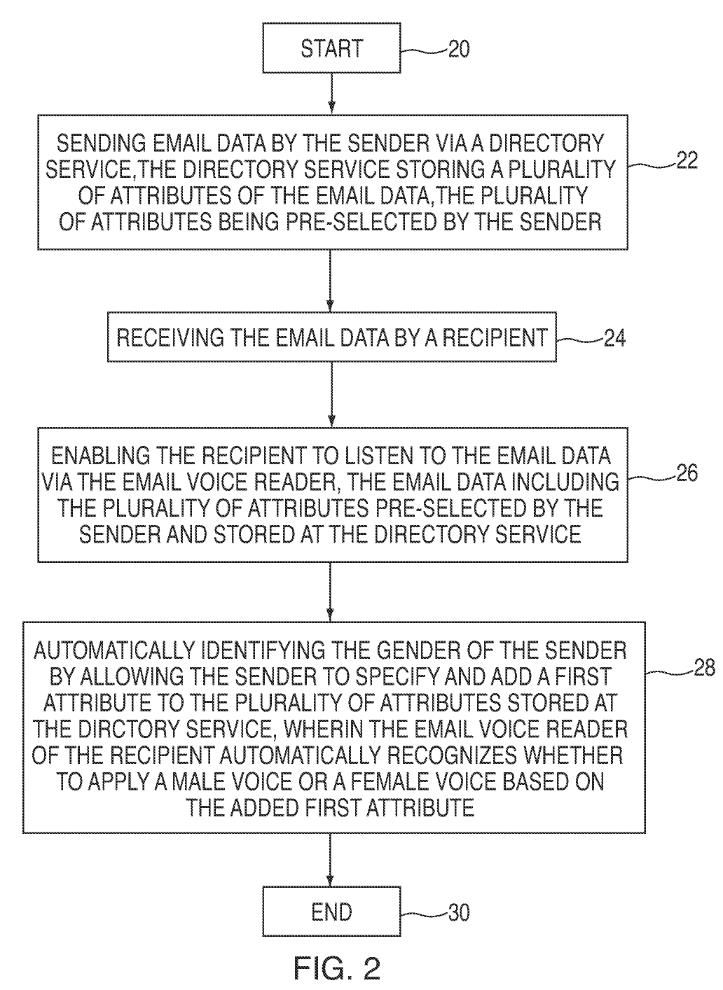

Referring to FIG. 2, one example of a flowchart illustrating an email reader capable of adapting the gender and/or emotions of a sender according to the exemplary embodiments of the present invention is illustrated. In step 20, the process starts. In step 22, the sender sends an email via a directory service, the directory service storing a plurality of attributes of the email data, the plurality of attributes being pre-selected by the sender. In step 24, the recipient receives the email data sent by the sender. In step 26, the recipient listens to the email data via the email voice reader, the email data including the plurality of attributes pre-selected by the sender and stored at the directory service. In step 28, the gender of the sender is automatically identified by allowing the sender to specify and add a first attribute to the plurality of attributes stored at the directory service, wherein the email voice reader of the recipient automatically recognizes whether to apply a male voice or a female voice based on the added first attribute. In step 30, the process terminates.

Further customizations may be added to make the male or female voice feature more creative. For example, emotions can also be integrated into the email that enables the voice to express some emotions. As an example, when a person wishes to send a “flame” type of email, in conventional terms, that person could perhaps include an image of an actual fire flame. Thus, that person can specify that he/she wants to use an angry voice. The receiver's text to speech software would accommodate for such changes in emotions. Similarly, emotions can be specified for an “excited” or a “sad” email. In addition attributes can consist of formatting of text and/or formatting of objects.

Allowing the sender to employ voice font while composing the email note can be another method for cueing the mail reader to appropriately read a received email according to sender's gender and emotion. For instance, a voice font is a technology that allows document composers to add voice specific pronunciation to a given document, while doing so, that same document composers, can customize the sounds well enough to mimic as closely as possible the emotional effect they would want to send along with the text document. Essentially, the exemplary embodiments illustrate an email client that has the voice font available for mail composition, and an enhanced text-to-speech engine that can intelligently read notes composed with voice fonts. In addition, the exemplary embodiments look up gender and voice characteristics of a sender on a server of a directory service, not as a part of the email metadata.

In addition, in the exemplary embodiments of the present invention, information (e.g., gender) about the sender may be retrieved by making a request to a directory service (e.g., LDAP—Lightweight Directory Access Protocol). Also, the email reader can be pre-configured to connect to the corporate central LDAP directory or it can be looked up on a publically available directory where a person's profile can be searched using the email address. Using the retrieved information from the directory service, the output of the email is presented to a reader in a format corresponding to the retrieved information from the directory service (e.g., presented in a male voice for a male sender, or in a female voice for a female sender, or in a kid's voice for a young person, an old voice for an older person, etc., as determined from the request to the directory service). A user composing an email can also create an LDAP entry specifying some attributes (the gender may be derived from inspecting the first name) and deriving from the LDAP entry certain other attributes, such as age (e.g., the person has been with IBM 99 years, thus the person is very old)

Furthermore, concerning the LDAP directory, each person's attributes may be stored in an LDAP directory. Attributes such as gender, nationality, accent, color of the email background for the people who can't hear, etc. may be stored. These attributes give a more personalized touch to an email. Using a link to an LDAP can retrieve the above-mentioned attributes. This would work if the sender and receiver have common LDAP software capabilities. Also when a person copies a part of the email as text from one email and paste it into another email, then the link to the attributes for that portion should be copied as well. This feature is also available during replies to emails and for forwarding emails as well.

To summarize, a method for an email reader capable of adapting the gender and/or emotions of a sender has been described where the sender is able to attach a tag to the email including the male or female gender property wherein when the recipient receives the email, it is read in the male or female voice, as specified by the sender. Furthermore, the sender can also embed tags in the text of the email indicating his/her emotions, so when the email is converted from text to speech for the recipient, the voice reflects the emotions of the sender. The information from the sender can further be stored in the address book of the recipient, so when the recipient receives an email from this sender, it is presented to the recipient in the format desired by the sender.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for an email voice reader capable of adapting gender and emotions of a sender, the method comprising:
sending email data by the sender via a directory service, the directory service storing a plurality of attributes of the email data, the plurality of attributes being pre-selected by the sender;
receiving the email data by a recipient;
enabling the recipient to listen to the email data via the email voice reader, the email data including the plurality of attributes pre-selected by the sender and stored at the directory service; and
automatically identifying the gender of the sender by allowing the sender to specify and add a first attribute to the plurality of attributes stored at the directory service, wherein the email voice reader of the recipient automatically recognizes whether to apply a male voice or a female voice based on the added first attribute.

2. The method of claim 1, wherein the sender is permitted to specify and add a second attribute to the plurality of attributes, the second attribute being an emotion attached to the male voice or the female voice.

3. The method of claim 1, wherein the sender is permitted to specify and add a third attribute to the plurality of attributes, the third attribute being one or more colors attached to the male voice or the female voice.

4. The method of claim 1, wherein the sender is permitted to specify and add a fourth attribute to the plurality of attributes, the fourth attribute being a text formatting function.

5. The method of claim 1, wherein the sender is permitted to specify and add a fifth attribute to the plurality of attributes, the fifth attribute being an object formatting function.

6. The method of claim 1, wherein the directory service is a corporate central directory service.

7. The method of claim 1, wherein the directory service is a publically available directory.

8. The method of claim 1, wherein the male voice is a voice selected from a plurality of male voices stored at the directory service.

9. The method of claim 1, wherein the female voice is a voice selected from a plurality of female voices stored at the directory service.

10. A system for an email voice reader capable of adapting gender and emotions of a sender, the system comprising:
a network; and
a host system in communication with the network, the host system including voice reader application software to implement a method comprising:
sending email data by the sender via a directory service, the directory service storing a plurality of attributes of the email data, the plurality of attributes being pre-selected by the sender;
receiving the email data by a recipient;
enabling the recipient to listen to the email data via the email voice reader, the email data including the plurality of attributes pre-selected by the sender and stored at the directory service; and
automatically identifying the gender of the sender by allowing the sender to specify and add a first attribute to the plurality of attributes stored at the directory service, wherein the email voice reader of the recipient automatically recognizes whether to apply a male voice or a female voice based on the added first attribute.

11. The system of claim 10, wherein the sender is permitted to specify and add a second attribute to the plurality of attributes, the second attribute being an emotion attached to the male voice or the female voice.

12. The system of claim 10, wherein the sender is permitted to specify and add a third attribute to the plurality of attributes, the third attribute being one or more colors attached to the male voice or the female voice.

13. The system of claim 10, wherein the sender is permitted to specify and add a fourth attribute to the plurality of attributes, the fourth attribute being a text formatting function.

14. The system of claim 10, wherein the sender is permitted to specify and add a fifth attribute to the plurality of attributes, the fifth attribute being an object formatting function.

15. The system of claim 10, wherein the directory service is a corporate central directory service.

16. The system of claim 10, wherein the directory service is a publically available directory.

17. The system of claim 10, wherein the male voice is a voice selected from a plurality of male voices stored at the directory service.

18. The system of claim 10, wherein the female voice is a voice selected from a plurality of female voices stored at the directory service.
